(19) United States
(12) Patent Application Publication
(10) Pub. No.: US 2011/0108580 A1
(43) Pub. Date: May 12, 2011

(54) Pump

(76) Inventor: Teng Hwee KOH, Singapore (SG)

(21) Appl. No.: 12/944,755

(22) Filed: Nov. 12, 2010

Related U.S. Application Data
(60) Provisional application No. 61/260,821, filed on Nov. 12, 2009.

(51) Int. Cl. B67D 7/58; B67D 7/78

(52) U.S. Cl. 222/377; 222/464.7

(57) ABSTRACT

A container has a top having an opening for filling the container with a content. The container has a bottom having a general gradient, and a side surface intermediate the top and the bottom. The container has a collection reservoir disposed at a lowest part of the bottom, in which the general gradient of the bottom directs the content of the container to the collection reservoir.

### CROSS-REFERENCE TO RELATED APPLICATION

This application claims the benefit of U.S. Provisional Patent Application No. 61/260,821 filed on Nov. 12, 2009, the entire contents of which are herein incorporated by reference.

### BACKGROUND

Liquids such as shower creams, hand soap, facial cream, cosmetics or any detergents that are stored in a plastic bottle and dispensed by a pump are widely used at private and public places. Such pumps enable users to obtain a precise volume of contents, provide users with clean and comfortable usages and avoid potential cross-contamination by users.

In a conventional pump bottle, a gap is provided between the straw end and the bottom of the bottle or a notch is provided at the straw end, as shown in FIGS. 1 and 2. However, a pump can normally not completely dispense all the contents in a bottle. This causes wastages, as contents are not able to be pumped out completely.

The left over contents usually need to be poured out manually by removing the pump and turn the bottle upside down. This creates inconvenience to users. Additionally, a required amount of the contents can no longer be controlled. The wastage results in additional cost. Moreover, mixing with water to dilute the viscosity for easy pouring becomes a common phenomenon in bath rooms, as most of liquids are of higher viscosity. The pouring out of such diluted fluids is cumbersome.

### SUMMARY

Embodiments relate to a container. The container has a top having an opening for filling the container with a content. The container has a bottom having a general gradient, and a side surface intermediate the top and the bottom. The container has a collection reservoir disposed at a lowest part of the bottom, in which the general gradient of the bottom directs the content of the container to the collection reservoir.

Such containers can be used to store liquid shower creams, hand soap, facial cream, cosmetics or any other detergents. Storing other types of fluids or creams may also be useful. Such containers can be used at private and public places.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. Embodiments will now be described, by way of example with reference to the drawings of which:

FIGS. 1-2 show various pump bottles;

FIG. 3 shows an embodiment of a pump bottle;

FIG. 4 shows an embodiment of a pump bottle;

FIG. 5 shows an embodiment of a pump bottle; and

FIG. 6 shows an embodiment of a pump bottle.

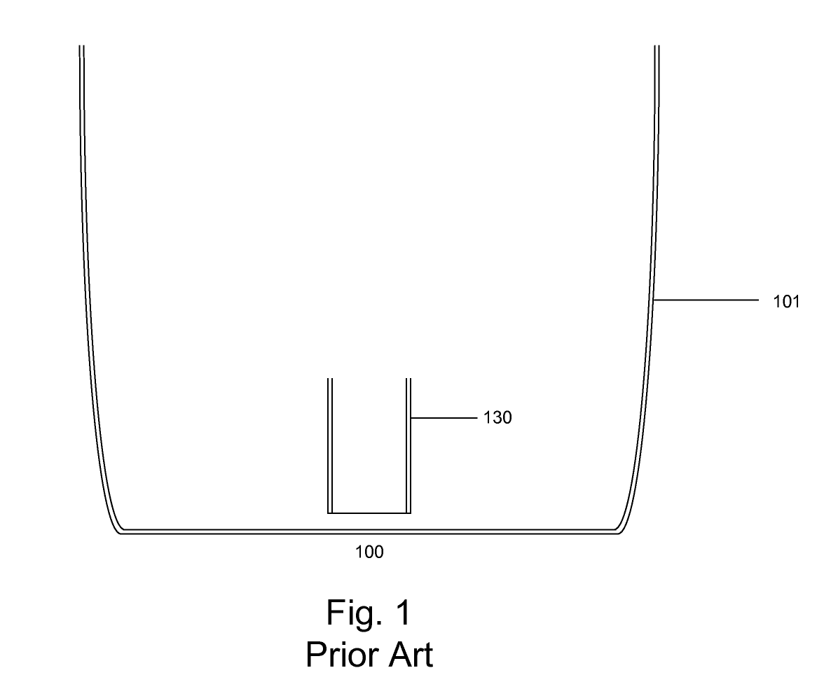

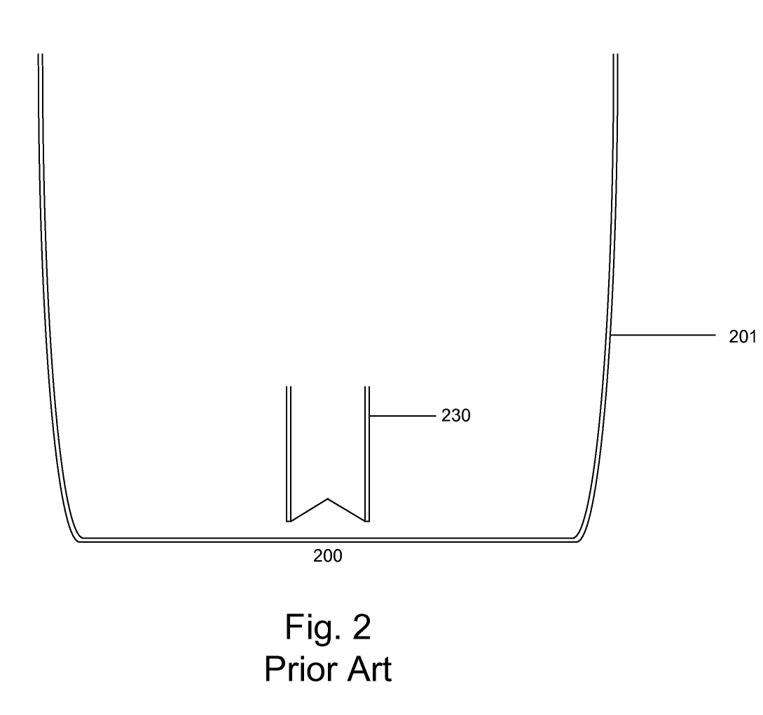

### DETAILED DESCRIPTION

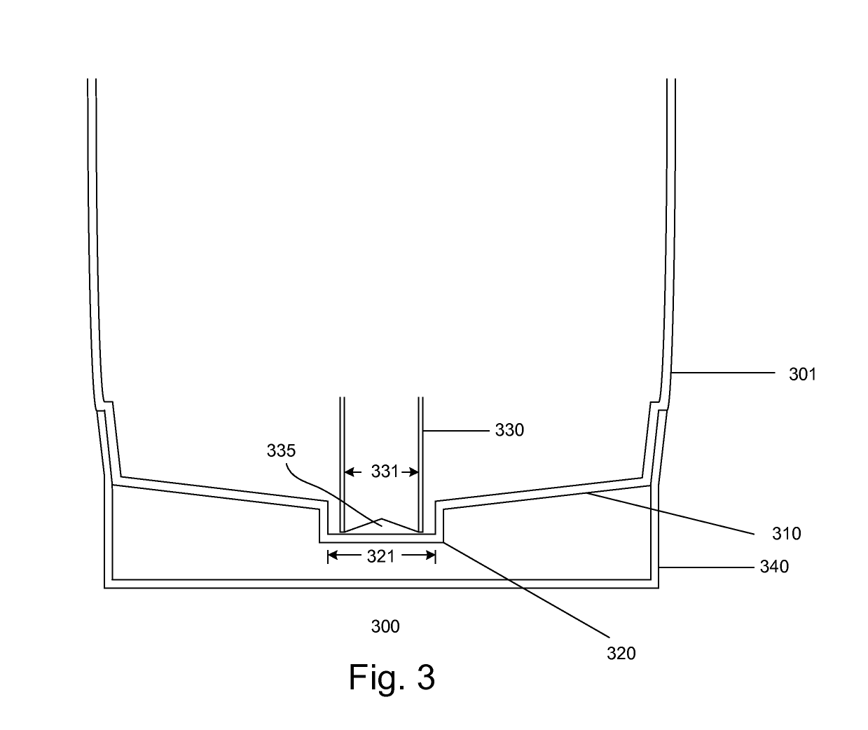

In FIG. 3, an embodiment of a pump bottle 300 is shown. The pump bottle may be any type of bottle or container. For example, the bottle may be a vessel, receptacle, vial or other suitable containers. The bottle can be formed from various types of materials. For example, the bottle may be formed from plastic, glass or metal. The bottle may be transparent, translucent or opaque. Other types of materials may also be useful. The bottle includes a top (not shown), sides 301 and a bottom 310.

In one embodiment, a top of the bottle accommodates a pump. The pump for example, includes a dispensing nozzle (not shown) and a straw 331. The pump, for example, may be a manual pump. When the pump is actuated, such as by pushing downwards, contents of the bottle are siphoned through the straw and out through the dispensing nozzle. The contents of the bottle may be any type of liquid. Dispensing other types of materials by the pump may also be useful. The dispensing nozzle may be a spray nozzle or a non-spray nozzle. Other types of pumps may also be useful.

The sides may be parallel or substantially parallel. In other embodiments, the sides may be tapering toward each other at the bottom. Other bottom shapes, may also be useful. In one embodiment, the sides and the bottom are distinct. For example, the sides and bottom may have an abrupt change in direction. As shown, the sides and the bottom may have an angle θ. In one embodiment, the angle θ is greater than 90°. The angle θ should be sufficient to cause contents of the bottom to flow to a collection area 320 at the bottom surface. For example, the angle θ may be between about 95-135°. Other angles between the bottom and sides which cause contents to be directed to the collection area may also be useful.

In other embodiments, the sides and the bottom of the bottle may have a smooth transition. For example, the lower sides of the bottle and the bottom do not form an abrupt angle. For example, the sides and the bottom may have a smooth transition. In yet other embodiments, the sides may taper to form a V shape bottle, with the collection area located at the bottom of the V. Other configurations of the sides and the bottom may also be useful.

In one embodiment, the collection area comprises a distinct area in the bottom. For example, the collection area comprises a recessed portion of the bottom surface. The collection area or recess may have various shapes. For example, the recess may have a cylindrical, domical, ovate, conical, cubical, or oblong shape. Other shapes for the recess may also be useful. Providing a collection area which is not distinct form the bottom surface may also be useful.

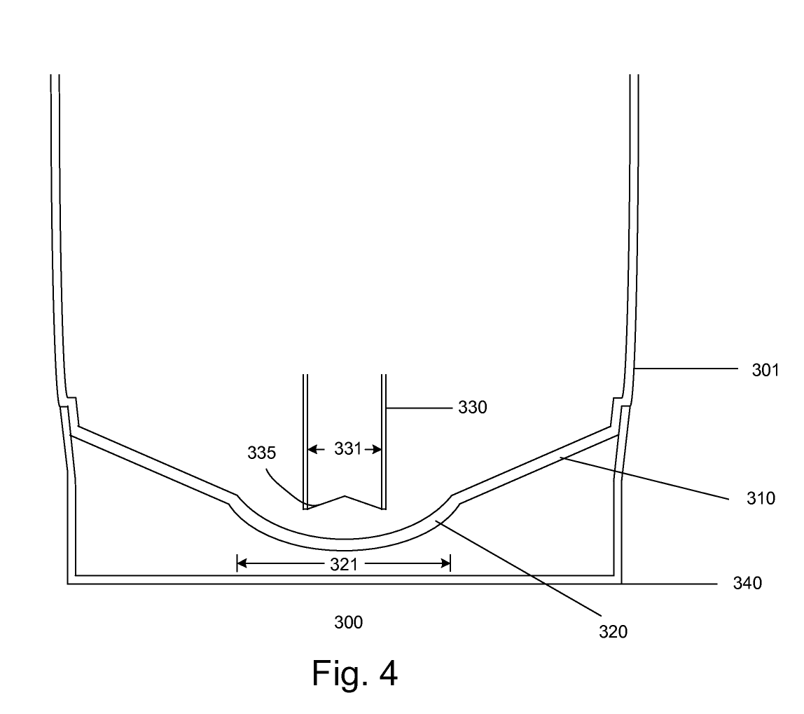

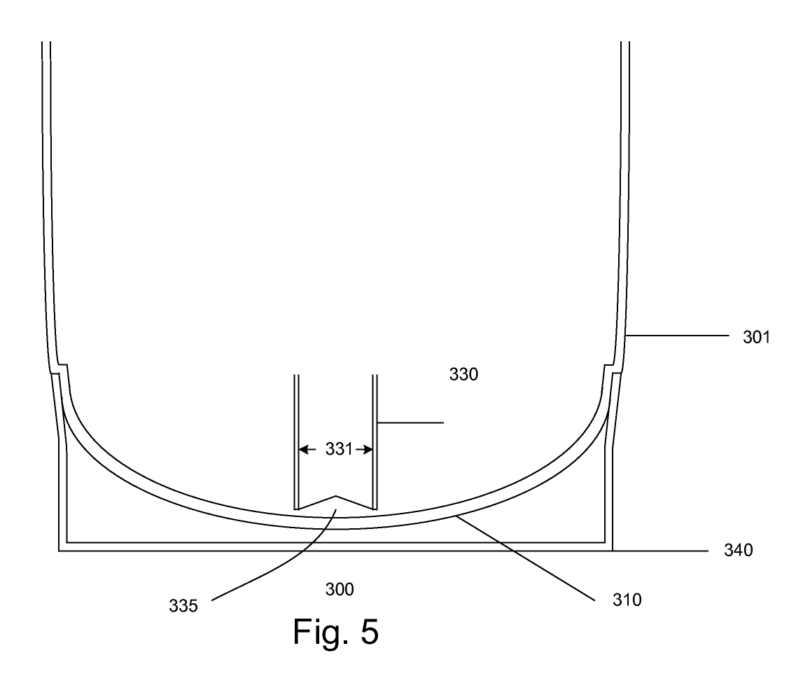

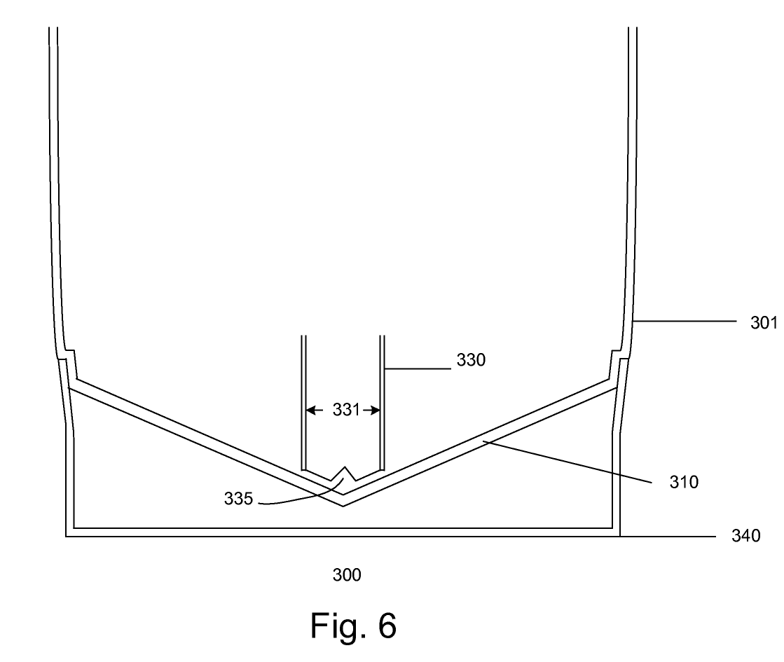

The collection area, in one embodiment, is a lowest portion of the bottom surface. For example, the bottom surface slopes downward toward the collection area. The sloping bottom surface may comprise a constant slope. In other embodiments, the bottom surface may comprise a variable slope. Other configurations of bottom surface and collection area may also be useful. For example, the bottom surface may comprise a combination of constant and variable sloping portions, as shown in, for example, FIGS. 4-6. For example, the bottom may have any type of shape, such as a conical, a domical or a plurality of converging planes or other shapes, which directs the contents of the bottom to the collection area. The general slope or gradient of the bottom to the collection area may be configured appropriately depending on the contents of the bottle. For example, a steeper general gradient may be used for the bottom for more viscous fluids.

The collection area may be located at a central portion of the bottom surface. In other embodiments, the collection area may be disposed in other parts of the bottom surface. The collection area serves as a reservoir for contents of the bottle. For example, the reservoir enables the last remaining contents of the bottle to collect at the collection area.

The collection area should be sufficient to accommodate the end of the straw of the pump. For example, the collection area should be larger in diameter than the straw of the pump. In one embodiment, the collection area should be slightly larger than the diameter of the straw. In one embodiment, the end includes at least one notch 335. The notch, for example, may be a v-shaped notch. Other types of shaped notches may also be useful. The notch allows liquid in the collection area to be drawn through the straw for dispensing by the pump.

In one embodiment, the bottom of the bottle may be fitted with a bottom cap 340. The bottom cap, for example, provides a flat surface at the bottom of the bottom for it to stand. The cap, for example, may be an integral part of the bottle. In other embodiment, the cap may be a separate component to the bottle.

The collection area serves as a reservoir for the last remaining contents of the bottle. This enables almost all the contents to be plumped out easily. The leftover contents in the recess will be a small negligible amount.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A container comprising:
a top having an opening for filling the container with a content;
a bottom having a general gradient;
a side surface intermediate the top and the bottom; and
a collection reservoir disposed at a lowest part of the bottom, wherein the general gradient of the bottom directs the content of the container to the collection reservoir.

2. The container of claim 1 wherein the collection reservoir comprises a recess.

3. The container of claim 2 wherein the width of the recess is bigger than the diameter of a straw for use with the container.

4. The container of claim 2 wherein the recess is cylindrically shaped.

5. The container of claim 2 wherein the recess is located at the lowest part of the collection reservoir.

6. The container of claim 1 wherein the collection reservoir comprises a concave plane.

7. The container of claim 6 wherein the collection reservoir comprises a recess.

8. The container of claim 7 wherein the recess is located at the center of the concave plane.

9. The container of claim 1 wherein the collection reservoir comprises a plane defining a conical portion.

10. The container of claim 9 wherein the collection reservoir comprises a recess.

11. The container of claim 10 wherein the recess is located at the lowest part of the collection reservoir.

12. The container of claim 1 further comprising a cap to support the container.

13. The container of claim 12 wherein the cap is covers the bottom of the container.

14. The container of claim 1 further comprising a pump.

15. The container of claim 1 further comprising a manual pump.

16. The container of claim 1 wherein the bottom comprises a plurality of sloping portions.

17. The container of claim 16 wherein one of the sloping portions is a constant sloping portion.

18. The container of claim 16 wherein one of the sloping portions is a variable sloping portion.

19. The container of claim 1 wherein the collection reservoir is at a central portion of the bottom surface.

20. The container of claim 1 wherein the bottom and the side surface form a distinct transition.
